(19) United States
(12) Patent Application Publication
(10) Pub. No.: US 2009/0254998 A1
(43) Pub. Date: Oct. 8, 2009

(54) WEB-BROWSER BASED GRID COMPUTING SYSTEM

(75) Inventor: Jennifer Wilson, Houston, TX (US)

Correspondence Address: CONLEY ROSE, P.C.;David A. Rose, P. O. BOX 3267, HOUSTON, TX, 77253-3267, US

(73) Assignee: PLURA PROCESSING, LP, Houston, TX (US)

(21) Appl. No.: 12/412,736

(22) Filed: Mar. 27, 2009

Related U.S. Application Data
(60) Provisional application No. 61/042,903, filed on Apr. 7, 2008.

(51) Int. Cl. G06F 15/16; G06F 21/20; G06F 15/177

(52) U.S. Cl. 726/27; 709/201; 709/220

(57) ABSTRACT

A system and method for web-based grid computing are disclosed herein. A method for web-based grid computing includes receiving a data component request from a node computer of a grid computing system. The request indicates that the node computer is configured to process the data component as a part of the grid computing system. A data component is sent to the node computer in response to the request. The data component is configured to be processed by a grid computing system web-based processing program executing in a web browser of the node computer. A grid computing client program is provided that is included on a web page accessed by the node computer. The client program is configured to be executed in the web browser of the node computer, and when executed causes the node computer to operate as a part of the grid computing system.

### CROSS-REFERENCE TO RELATED APPLICATION

The present application claims the benefit of U.S. Provisional Application Ser. No. 61/042,903, filed Apr. 7, 2008.

### FIELD OF INVENTION

The invention relates generally to grid computing systems. In particular, the invention relates to a grid computing system that uses code embedded in web-pages to distribute grid computer programming.

### BACKGROUND

A number of organizations (including SETI@home and Folding@home) currently use grid/distributed computing. Typically, grid computing systems require a client application to be installed on a single node computer. Because of user recalcitrance to spending both their time and their computers' hard drive resources, this installation requirement makes it very challenging to obtain a large number of node computers, which in turn limits the computational power of a grid computing system. A technology that allows faster distribution, less user inertia to implementation, and thus wider access to node computers is desired.

Traditionally, computer software has been written for serial computation. To solve a problem, an algorithm is constructed and implemented as a serial stream of instructions. These instructions are executed on a central processing unit on one computer. Only one instruction may execute at a time-after that instruction is finished, the next is executed. Parallel computing, on the other hand, uses multiple processing elements simultaneously to solve a problem. This is accomplished by breaking the problem into independent parts so that each processing element can execute its part of the algorithm simultaneously with the others. The processing elements can be diverse and include resources such as a single computer with multiple processors, several networked computers, specialized hardware, or any combination of the above. The result is an increase in efficiency and speed of processing.

“Distributed” or “grid” computing in general is a special type of parallel computing which relies on complete computers (with onboard CPU, storage, power supply, network interface, etc.) connected to a network (private, public or the Internet) by a conventional network interface, such as Ethernet or broadband. This is in contrast to the traditional supercomputer, which has many processors connected by a local high-speed computer bus. A grid computing system uses the resources of many separate computers, loosely connected by a network (usually the Internet), to solve large-scale computation problems. It is a form of distributed computing whereby a “super and virtual computer” is created from networked, loosely-coupled computers acting in concert to perform very large tasks. Public grids may use idle time on many thousands of computers throughout the world. Such arrangements permit handling of data and computations that would otherwise require the power of expensive supercomputers or would have been impossible to analyze.

The primary advantage of distributed computing is that each individual computer, when utilized as a “node,” can be purchased as commodity hardware. Combining multiple nodes can produce computing resources similar to a multiprocessor supercomputer, but at lower cost. This is due to the economies of scale of producing commodity hardware, compared to the lower efficiency of designing and constructing a small number of custom supercomputers. The high-end scalability of geographically dispersed grids is generally favorable, due to the low need for connectivity between nodes relative to the capacity of the public Internet. There are also some differences in programming and deployment. It can be costly and difficult to write programs so that they can be run in the environment of a supercomputer, which may have a custom operating system, or require the program to address concurrency issues. If a problem can be adequately parallelized, a “thin” layer of “grid” infrastructure can allow conventional, standalone programs to run on multiple machines (but each given a different part of the same problem). This makes it possible to write and debug on a single conventional machine, and eliminates complications due to multiple instances of the same program running in the same shared memory and storage space at the same time. One feature of distributed grids is that they can be formed from computing resources belonging to multiple individuals or organizations (known as multiple administrative domains). This can facilitate commercial transactions, as in utility computing, or make it easier to assemble volunteer computing networks.

In distributed grid computing, a program is split up and apportioned by software into parts that run simultaneously on multiple computers communicating over a network. As stated previously, distributed computing is a form of parallel computing, but parallel computing is most commonly used to describe program parts running simultaneously on multiple processors in the same computer. Both types of processing require dividing a program into parts that can run simultaneously, but distributed programs often must deal with heterogeneous environments, network links of varying latencies, and unpredictable failures in the network or the computers. The main goal of a distributed computing system is to connect users and resources in a transparent, open, and scalable way. This arrangement can be considerably more fault tolerant and more powerful than many combinations of stand-alone computer systems.

Due to modern processors and other advances in computer technology, the computing resources of a single computer are invariably underutilized. When such a computer, utilizing minimal resources, is used as a node computer, a large amount of the unused processing power is available for grid computing (or, e.g., distributed internet computing). This is known as CPU-scavenging, cycle-scavenging, or shared computing, and it creates a “grid” from the unused resources in a network of participants. Typically this technique uses desktop computer instruction cycles that would otherwise be wasted at night, during lunch, or even in the scattered seconds throughout the day when the computer is waiting for user input or slow devices, in short, when the computer is idle.

Grid computing technology has been applied to computationally-intensive scientific, mathematical, and academic problems through volunteer computing, and it is used in commercial enterprises for such diverse applications as drug discovery, economic forecasting, seismic analysis, and back-office data processing in support of e-commerce and web services. A number of organizations (including SETI@home and Folding@home) use grid distributed computing to carry out high performance, computationally intensive computing, wherein multiple node computers each process a piece of a larger computational assignment. These and many other grid computing systems are run on a volunteer basis, and involve single computers, acting as nodes, donating their unused computational power to work on interesting computational problems.

There are several inefficiencies in the current grid computing systems. Grid computing systems typically require the use of application software that is downloaded through the internet and then installed on a node computer. The application software runs on the node computer and utilizes that computer's resources when the computer is idle. This means that the node computer is not being used for other tasks while the application software is running. Further, because application software must be downloaded and installed to the node computer in a typical grid computing system, user inertia to implementation exists-the user of a potential node computer must be willing to sacrifice time and hard drive space for the installation. Moreover, the node computer user must “trust” the provider of the grid computing system, for it is possible for disreputable software developers to use the application software to permit unauthorized data access on the node computer, or to view and distribute any data (email, private documents, web history, etc.) on the node computer. Additionally, disreputable developers can use the application to download new application software to the computer, which can be run without the knowledge of the node computer user. These new applications may be used to force the host computer to perform any task desired (SPAM, virus, spyware, botnet, etc.) by the developers.

Thus, as described above, traditional grid computing schemes present a variety of problems and inefficiencies that limit their usefulness.

### SUMMARY

One embodiment described herein is directed to a grid computing method, wherein an applet or similar web-based program is placed on at least one affiliate web page whereby when a node computer web browser accesses the affiliate web page, the node computer performs at least one designated computing function, as specified by a processing server, whereby the node computer operates as a part of a distributed computing network. The processed information resulting from performing the computing function is sent from the node computer to the processing server, which sends it to the application server where use or further analysis by the customer may be performed. Such an embodiment of a grid computing system is well-suited for performing computationally-expensive computing or bandwidth-intensive computing, including functions such as stock market algorithm analysis, other financial market analysis, web crawling, distributed internet data mining, Monte Carlo simulations, parameter sweeps, weather prediction, and any other algorithm distributable in a parallel manner requiring large amounts of computational power or internet bandwidth.

Another embodiment is directed to a system which performs the method, permitting grid computing by node computers actively browsing the internet, without installing application software on the node computers. The number of node computers can be continually expanded by placing passive or interactive programs containing interlaced code on more affiliate web pages, or attracting more browsers to other web pages that contain the interlaced code.

The disclosed grid computing method utilizes the node computers' excess computing resources, which implies that there is little to no value to the individual node regarding these excess computing resources, but a high value to such resources when all nodes are aggregated. Therefore, the disclosed grid computing method may obtain these resources at a very low cost and provide an economical, efficient, and readily scalable means for node computers to be a part of the grid computing network. The grid computing method may then be used by various customer applications at a lower cost, despite the large amount of aggregate computing resources available, than that customer would pay to develop its own computer resource system.

In some embodiments, a method includes receiving a data component request from a node computer of a grid computing system, the request indicates that the node computer is configured to process the data component as a part of the grid computing system, sending a data component to the node computer, the data component is configured to be processed by a grid computing system web-based processing program executing in a web browser of the node computer, and causing the node computer to apply the processing program to the data component to produce a result. In further embodiments, the web-based processing program is downloaded to the node computer such that the processing program executes in the web browser of the node computer and performs a processing function of the grid computing system. In still further embodiments, the method includes providing a grid computing client program included on a web page accessed by the node computer, the client program is configured to be executed in the web browser of the node computer, and when downloaded to the node computer causes the node computer to operate as a part of the grid computing system.

In some embodiments, a computer readable medium encoded with a computer program includes instructions that when executed cause a processor to receive a data component request from a node computer of a grid computing system, the request indicates that the node computer is configured to process the data component as a part of the grid computing system, instructions that when executed cause a processor to send a data component to the node computer, the data component is configured to be processed by a grid computing system web-based processing program executing in a web browser of the node computer, and instructions that when executed cause the node computer to apply the processing program to the data component to produce a result.

In some embodiments, a computer readable medium encoded with a computer program includes instructions that when executed cause a processor to download from a first computer to a second computer a web-based program that executes in a web browser of the second computer, and instructions that when executed cause a processor to configure the second computer to operate as a node of a grid computing system by execution of the web-based program. In further embodiments, the computer readable medium includes instructions that when executed cause a processor to configure the second computer to perform a grid computing system processing function during a time interval when the computing resources of the second computer are not fully utilized. In still further embodiments, the computer readable medium includes instructions that when executed cause a processor to configure the second computer to operate as a node of the grid computing system during an interval in which the web browser of the second computer accesses a web page comprising the web-based program.

In some embodiments, a grid computing system includes a first computer comprising a grid computer processing server and a network connection configured to couple the first computer to a plurality of node computers, wherein the grid computer processing server is configured to receive data component requests from the plurality of node computers, each request indicating that a node computer is configured to process the data component as part of the grid computing system, wherein the grid computer processing server is configured to send a data component to a given node computer in response to receiving a data component request from the given node computer, the data component is configured to be processed by a grid computing system web-based processing program executing in a web browser of the node computer. In further embodiments, the first computer distributes a web-based processing program to each of the plurality of node computers, the web-based processing program is configured to execute within a web browser of each node computer, and causes each node computer to perform processing function of the grid computing system. In still further embodiments, the grid computer processing server receives from a customer application server, via the network, a work item and a web-based processing program configured to process the work item, segments the work item into data components, assigns an identifier to each component, and transmits the identifiers to the customer application server.

In some embodiments, a method includes downloading a web-based processing function and a work unit to process with the processing function to a node computer of a grid based computing system, and computing a remuneration based on a number of work units processed by the node computer. In further embodiments, the method includes providing the remuneration to a proprietor of a web page that downloads a web-based program to the node computer, the web-based program causes the node computer to operate as part of the grid based computing system.

### BRIEF DESCRIPTION OF THE DRAWINGS

FIG. 1 is a block diagram of an exemplary web-based grid computing system showing an overview of the “capture” of a single node computer accessing an internet web site via a web browser in accordance with various embodiments. The string reversal code is but one example of the types of applications that can be incorporated into the web page interface.

FIG. 2 is a block diagram showing detail of the web-based grid computing system utilizing the resources of multiple node computers in accordance with various embodiments. The string reversal application is but one example of application types available.

FIG. 3 is a block diagram showing the detail of the web-based grid computing system utilizing a flash file accessed by a node computer upon visiting a specific web site in accordance with various embodiments.

FIG. 4 is a diagram representing an operation performed in creating a web-based grid computer system, wherein a single computer visits an affiliate web site containing the string code of the web-based grid computing system in accordance with various embodiments.

FIG. 5 is a diagram representing an operation performed by the system, wherein the computer visiting the affiliate web site establishes a connection with the grid computing server and thus establishes the computer as a node within the system in accordance with various embodiments.

FIG. 6 is a diagram representing an operation performed by the system, wherein the single computer, now functioning as a node, requests a work unit from the grid computing server in accordance with various embodiments.

FIG. 7 is a diagram representing an operation performed by the system, wherein the node receives a work unit from the grid computing server in accordance with various embodiments.

FIG. 8 is a diagram representing an operation performed by the system, wherein the node performs a computation on the work unit using the node's excess resources in accordance with various embodiments.

FIG. 9 is a diagram representing an operation performed by the system, wherein the node sends the result of the work unit computation to the grid computing server in accordance with various embodiments.

FIG. 10 is a diagram representing the initiation of a customer request to utilize the processing power of the web-based grid computing system, wherein a customer of the web-based grid computing system sends, via an application, a large number of work units to the grid computing server in accordance with various embodiments.

FIG. 11 is a diagram representing the distribution of work units by the grid computing server to nodes that will perform the calculations on the work units in accordance with various embodiments.

FIG. 12 is a diagram representing the computation of work units amongst many node computers in accordance with various embodiments.

FIG. 13 is a diagram representing the nodes returning completed work unit results to the grid computing server in accordance with various embodiments.

FIG. 14 is a diagram representing the grid computing server passing results of work units to the customer application in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Multiple organizations (including SETI@home and Folding@home) use grid computing, also known as distributed internet computing, to carry out high performance computing. These organizations typically require the use of a desktop application that must be actively installed on each participating computer (called a “node”). The desktop application then runs on that computer when the computer is idle in order use the node computer's resources. Such traditional grid computing schemes have numerous drawbacks as described above.

A more efficient and trustworthy means of creating a grid computing system utilizes embedded code within web pages rather than downloaded and installed software. Similar to an idle computer, a computer browsing the internet typically utilizes minimal computing resources, even when the computer is actively browsing, leaving a large amount of unused processing power available for grid computing. When these resources are captured, creating a node computer, there is no need to idle that computer to perform grid computing in a web-based system utilizing commands embedded in a web page or applet. Thus, such a web-based system for grid computing is more efficient and desirable than downloaded and installed application software based systems because not only is user interaction (and thus time) and hard drive space for installation unnecessary, but the node computer is also still functional to the user/owner of that computer even while its excess resources are utilized in the grid system.

To maximize the number of nodes available in an embedded web-page based grid computing system, a business arrangement may be used. Such an arrangement includes the contractual use of embedded Java applets, Flash movies, JavaScript content, Silverlight content and other potential web-based technologies including, for example, embedded Java and Flash-based games. The result is a method for monetizing such installation-free applications and content. Currently, for example, Flash developers must rely on advertising within their content, advertising on websites in which the content is embedded, revenue-sharing schemes, or other methods. All of these methods have inherent flaws. Advertising within content does not allow well-targeted advertisement delivery, resulting in poor monetization. Advertising on websites forces the Flash developer to either have some control over the websites (and thus the advertising revenue), or depend on the website owners for payment. Revenue-sharing schemes similarly put the Flash developers in a place of dependency on a third party. Flash developers will benefit from having a method of monetization that they can control from within their files and does not depend on the websites in which their content is embedded. Remuneration for the Flash developers can be computed based establishing nodes for the grid computing system and/or passing data components or results between the grid computing server and the nodes.

Typically, a single computer browsing the internet utilizes minimal computer resources. By performing grid computing via a web-based processing applet, as described herein, rather than an installed application, the drawbacks of traditional grid computing (as described above) are overcome. For instance, at least some embodiments of the invention do not access the hard drive of the node computer at all. Some embodiments allow for adjustment of the amount of node computer resources consumed by grid computing. The adjustments may be based on, for example, customer demand and/or node user tolerance. For example, an embodiment may limit peak grid computation node processor resource consumption to approximately 50% of the total node processor resources, thus allowing active use of the node computer instead of requiring idle time. Some embodiments may limit memory use to less than 100 Mb of memory. Some embodiments may adjust node computer resource consumption to provide processing of a work unit within a predetermined time interval. For example, resource consumption for a particular node computer may be adjusted to allow that node to process a work unit in approximately five minutes.

Additionally, utilizing a web-based applet for grid computing allows a dramatic increase in the number of node computers available for grid computing. Because the distribution of such applets via the World Wide Web is significantly faster than is distribution of user-installed programs, the inertia forestalling use of such non-installed applets is greatly diminished.

Because a desktop application must be installed on a node computer in a typical grid computing system, the owner of the node computer may further forego installation because of a lack of “trust” of the provider of the grid computing system. It is possible for disreputable software developers to use the installed desktop application to view and distribute any data (email, private documents, web history, etc.) on the node computer. Additionally, disreputable software developers can use the installed desktop application to download new desktop applications to the computer, which can be run without the knowledge of the host computer user. These new desktop applications may be used to force the node computer to perform any task desired (SPAM, virus, spyware, botnet, etc.) by the disreputable software developers. In the disclosed web-based grid computing system, the web browser that hosts all code-bearing iframes and applets ensures that the node computer is secure. The additional layer of security provided by the web browser further facilitates the voluntary implementation of the grid computing system.

The web-based grid computing system is shown in the diagrams as illustrations of the various individual elements and operations of the embodiments. In summary, in the disclosed grid computing system, an application server sends a work item through the internet to the grid computing processing server, which then segments the work item into data components and identifies each component with an identifier, and sends the segmented work item identifiers back to the application server. The application server supplies the grid computing processing server with a series of web-based programs which are respectively incorporated in or placed on a series of web pages, wherein each program is capable of initiating, in a computer which accesses one of the series of web pages via the internet, a computing function on an identified component which is retrieved from the processing server. The results from the computing function on the identified components are sent from the individual computers (now functioning as “nodes”) to the grid computing processing server, and are retrieved from there by the application server. In some embodiments, the results from the computing function on the nodes are sent to a third party or other computer or server. The system may be used with any parallel application.

Permission to initiate the grid computing system with a node is obtained either by a specific “Terms of Use” with disclosures to the user of the potential node computer or, in the alternative, such disclosure and permission may be obtained via a generalized “Terms of Use” form that appears upon accessing a grid-computing enabled website.

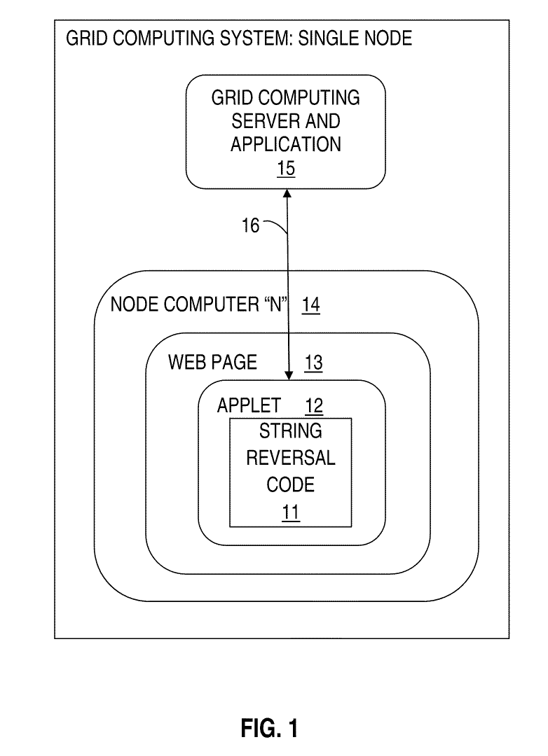

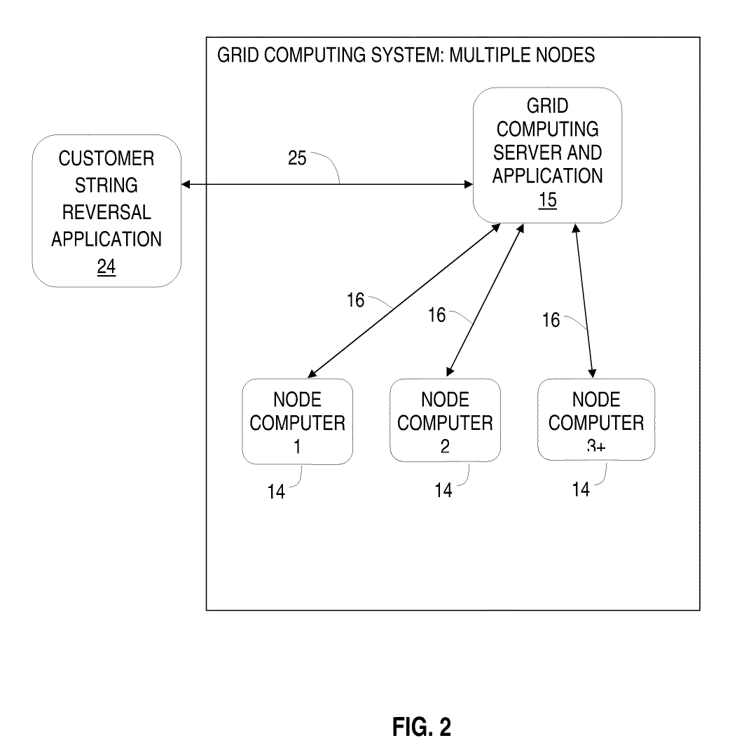

Referring now to FIG. 1, an embodiment of the grid computing system includes a server computer (15) and a node computer (14) connected via a network (16). String reversal code (11) is incorporated into an internet web page by an iframe using Java, Flash, or other applets (12). In the example of FIG. 1, “string reversal” is used as the desired application while it is understood that other application functions are available, and embodiments are not limited to any particular application. The applet is written wherein the incorporated string reversal code (11) performs the desired activity on each work item created from a string reversal application running external to the grid computer system (see FIG. 2). The iframe containing a link to the code is then placed on web pages (13) throughout the World Wide Web. When a web browser from the node computer (14) searching or accessing the internet accesses a web page containing the iframe, the applet and the code inside of the applet begin to run. Execution of the applet creates a node computer (14) (i.e., a computer configured to participate in grid system computations). The applet code first requests a data component, work item, or work unit from the grid computing server (15). A work item comprises at least a portion of a computation. In some embodiments, a work item comprises computation instructions and/or data. The applet requests the work item via a network connection (16) by sending an HTTP GET to a web service in the grid computing server application (15). The web service in the grid computing server application then returns an XML document to the applet (12). This XML document contains a single string reversal application work item. After the applet (12) receives the work item (which is a string to be reversed) it runs the string reversal code within the applet (12) while utilizing the resources of the node computer (14). The string reversal code (11) produces a result (the reversed string), which the applet (12) then sends back to the grid computing server application (15). The result may be sent via the network connection (16) by using an HTTP POST. The grid computing server application (15) then creates an association between the result and its corresponding work item and stores the result in an internally retrievable format.

Referring now to FIG. 2, the applet or other installation-free application runs simultaneously on a plurality of node computers (14). Each node (14), via the applet (12), performs the string reversal or other application action on a different work item and sends its own result to the grid computing server application (15) via a generalized World Wide Web internet connection (16).

Again referring to FIG. 2, and again with string reversal as an example application, in the grid computing system's commercial form, the string reversal application and the applet containing the string reversal code are provided by a customer (24) of the grid computing system. The customer string reversal application (24) sends its work (e.g., each of its 100 million strings to be reversed) to the grid computing server application (15). The application (24) sends the work via a network connection (25) by using an HTTP POST to send an XML document containing its work to a web service in the grid computing server application (15). The format of this XML document is standardized by the grid computing server application (15), and the document standard requires that each work item be identified as a separate entity. After the web service in the grid computing server application (15) receives the XML document from the customer string reversal application (24), it stores each work item in an internally retrievable format. The server application (15) then returns an XML document to the string reversal application (24). This XML document contains one grid computing server application specific identifier for each work item sent by the external string reversal application (24). The string reversal application (24) receives this XML document and stores each work item identifier in an internally retrievable format. These work item identifiers will be used by the string reversal application to retrieve the results of each of its work items.

Again referring to FIG. 2, the string reversal application (24) subsequently retrieves the results for its work items from the grid computing server application (15). The application (24) retrieves its work items via the network connection (25) by using an HTTP POST to send an XML document containing its work item identifiers to a web service in the grid computing server application (15). When the web service in the grid computing application (15) receives the XML document from the string reversal application (24), it retrieves the result for each work item and returns the results to the string reversal application (24) in an XML document.

Again referring to FIG. 2, by using the plurality of nodes (14) in the grid computing system, the customer string reversal application (24) is able to efficiently and quickly complete its task of, for example, reversing 100 million character strings, which would take an unreasonable length of time on any single computer. The same efficiency exists with any other application.

The grid computing system described herein may be implemented as a plurality of networked computers. A computer can be, for example, a personal computer, a workstation, a server computer, a mainframe or any other computing platform adapted to execute the programming of the grid computing system. Each computer, for example, the node computer 14 and the grid computing server 15, may include a processor (e.g., a general purpose microprocessor, or other or other type of processor) configured to execute software programming. More specifically, the processor can execute software programming including instructions that cause the processor to perform the grid computing operations described herein. The processor can be coupled by one or more buses to various storage devices (e.g., disk drives, optical storage devices, volatile and/or non-volatile semiconductor memories, etc.), network interfaces, printers, human interface devices, etc.

The software programming of the grid computer system, for example, the grid computing application and the client/node application can be stored in a computer readable medium accessible to the processor. A computer readable medium can be, for example, a magnetic storage medium (e.g., hard disk, floppy, tape, etc.), an optical storage medium (e.g., optical disk, tape, etc.), a semiconductor storage medium (e.g., random access memory, FLASH memory, etc.), or any other medium capable of storing computer instructions.

One of the embodiments of the invention is the creation of a widely distributed and monetized grid computing system via Flash file technology. Currently, remuneration for Flash developers includes certain flaws previously described. Flash developers in the disclosed grid computing system and method benefit from having a method of monetization that they can control from within their files and does not depend on the websites in which their content is embedded. Other installation-free applications and content, either now known or developed in the future, are also contemplated.

In one embodiment, the disclosed technology enables grid computing on node computers by embedding a grid computing client/node application (i.e., a web-based program that causes a computer to operate as a node of a grid based computing system) within a Flash file. When a computer runs the Flash file while connected to the Internet, the Flash file will in turn run the grid computing client/node application, allowing the computer to connect to the grid computing system and become a client/node within the network. The client/node application allows the system to utilize the resources of the computer for various applications. By connecting to computers via the World Wide Web through Flash, the grid computing system allows exploitation of the fact that client/node computers are only using a small percentage of their total computing resources while viewing or using a Flash file.

By providing creators of Flash files the ability to embed grid computing client applications within their files, embodiments allow for a wide distribution of grid computing and access to a large number of computers. If owners of the grid computing system pay Flash developers for the compute time provided by their Flash files, embodiments also provides Flash developers a new way of monetizing their applications and content, in a way that they can control, regardless of where that content is delivered.

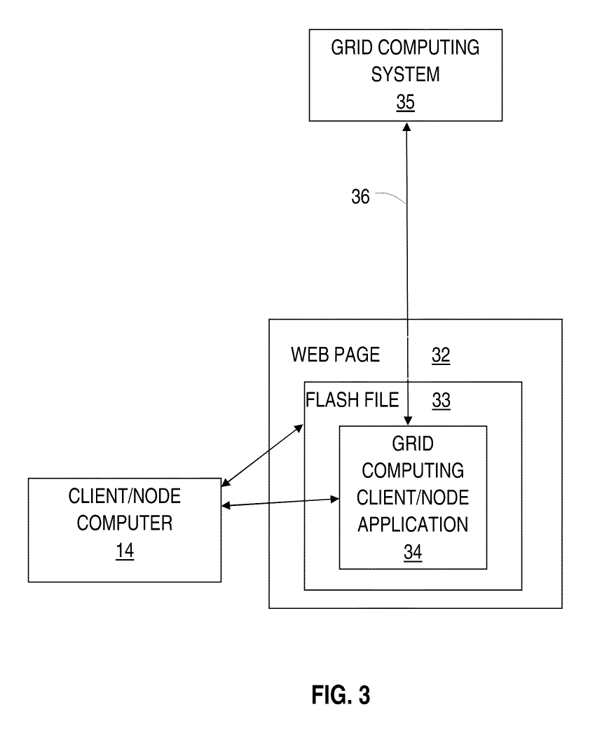

Referring now to FIG. 3, a computer (14) that accesses a web page (32) runs the flash file (33), which in turn initiates and runs the grid computing client/node application (34). The grid computing client/node application (34) establishes a connection via the internet (36) between the node computer (14) and the grid computing system (35). The grid computing system (35) can now send computing instructions (and possibly data) to the grid computing client/node application (34) running in association with the node computer (14). The client/node application (34) receives the instructions and data, performs the appropriate computations using the computing resources of the computer (14), and then sends the results of the computing back to the grid computing system (35). During the described grid computing process, the user of the client/node computer (14) may use and interact with the Flash file as if the file did not have the client application (34) embedded within it. Furthermore, the described process does not require a node user to download, install, and execute a grid computing application on the node computer.

The following examples further describe various embodiments.

### EXAMPLE 1

### Use of Commercial “Affiliates” to Distribute Web-Enabled Grid Computing Code

Affiliates are providers of web-enabled applications or content who are contractually paid (e.g., per work unit) to supply the grid computing system code within their web content or web applets/applications. In short, affiliates connect the grid computing system server to nodes (i.e., sources of computing power). Remuneration can be provided to the affiliates, such as by computing total sums of remuneration based on each work unit processed via the affiliates web page, web content, or web applets/applications. Though discussed sequentially as a matter of convenience, at least some of the operations discussed can be performed in a different order and/or performed in parallel. Additionally, some embodiments may perform only some of the operations discussed.

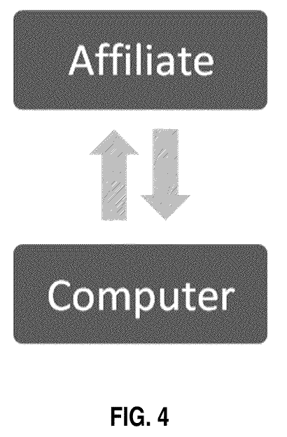

In an operation as shown in FIG. 4, a computer (e.g., node computer (14)) accesses the affiliate. For example, if the affiliate is a website, the computer user opens a web browser and accesses the affiliate website. Similarly, if the affiliate is a web-enabled application, the computer user runs the web-enabled application. Once the computer accesses the affiliate, the affiliate automatically initiates the grid computing system code. If the affiliate is a website, an iframe in the website's HTML code will launch a Java applet. If the affiliate is a web-enabled application, the application will run the integrated grid computing code. The result is the same: the computer becomes a node within the grid computing system.

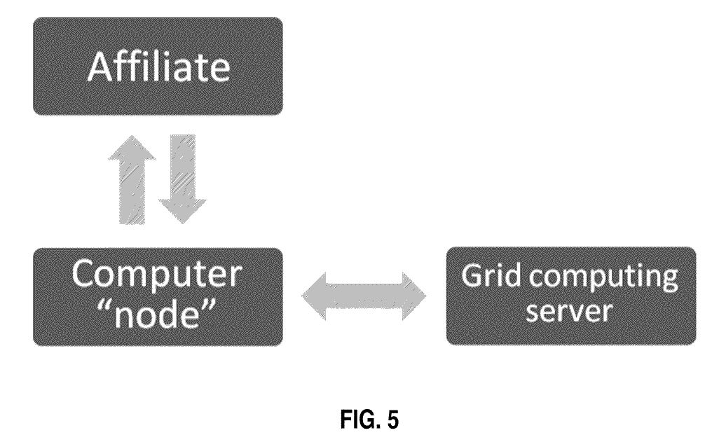

In an operation, as shown in FIG. 5, the computer (e.g., node computer (14)) visiting the affiliate establishes a connection with the grid computing server and thus establishes the computer as a node within the system.

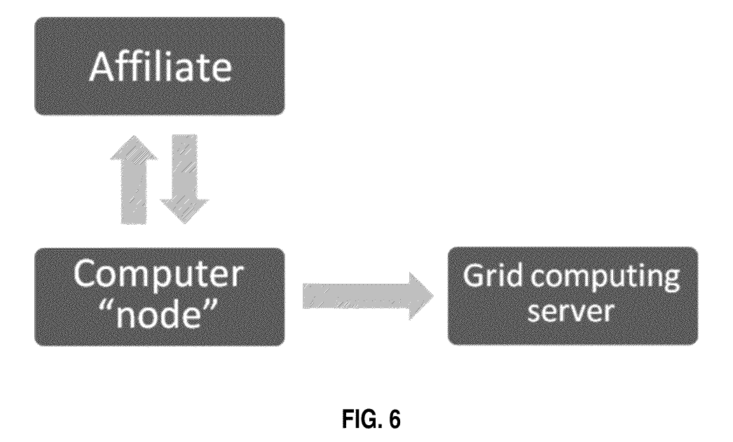

In an operation as shown in FIG. 6, the node requests a work unit from the grid computing server. A work unit comprises a portion of a computation. In some embodiments, a work unit comprises computation instructions and/or data. An exemplary work unit size is less than 2 megabytes.

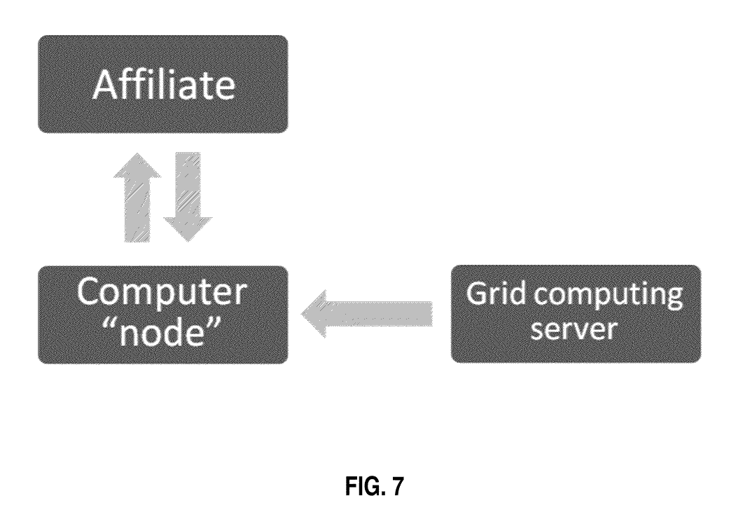

In an operation as shown in FIG. 7, the node receives a work unit from the grid computing server.

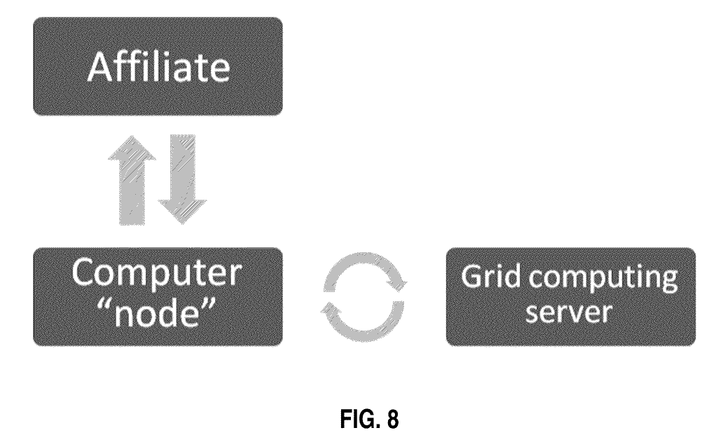

In an operation as shown in FIG. 8, the node uses resources to perform does computations related to the work unit according to the work unit's instructions. The affiliate can control the amount of node CPU resources that the grid computing system can use during computation. The compute time for work units may be kept short to increase the likelihood of completion of the work unit.

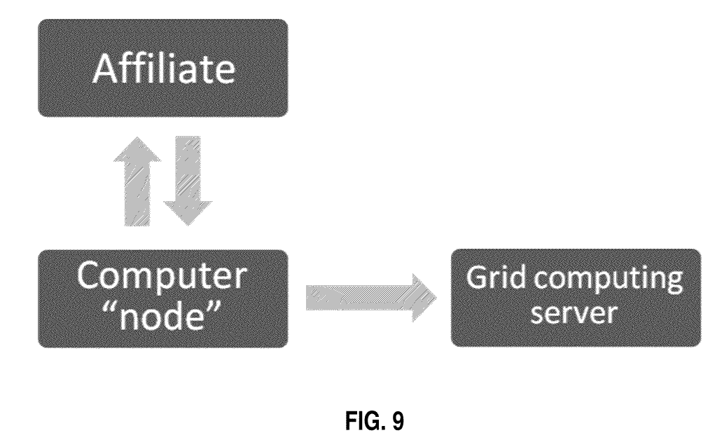

In an operation as shown in FIG. 9, after the work unit is completed, the result is sent back to the grid computing system server. The process may then be repeated with the node requesting further work units so long as the node remains connected to the grid computing system server. If the user of the node closes the web-based application or moves on to another web page, the connection is closed.

### EXAMPLE 2

### “Customer” Perspective of Commercial Web-Enabled Grid Computing

Customers of the grid computing system preferably pay to use the system to run computationally-intensive applications quickly by distributing computations across many computers. Though discussed sequentially as a matter of convenience, at least some of the operations discussed can be performed in a different order and/or performed in parallel. Additionally, some embodiments may perform only some of the operations discussed.

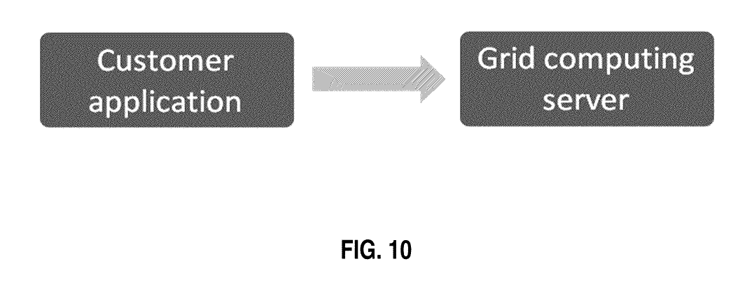

In an operation as shown in FIG. 10, a customer application sends a large number of work units to the grid computing server.

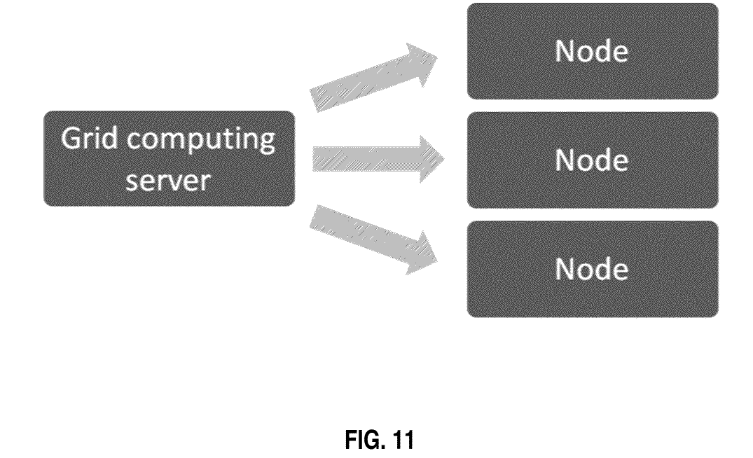

In an operation as shown in FIG. 11, the grid computing system server distributes these work units across the grid to various nodes. The work units may be distributed across, for example, thousands of nodes.

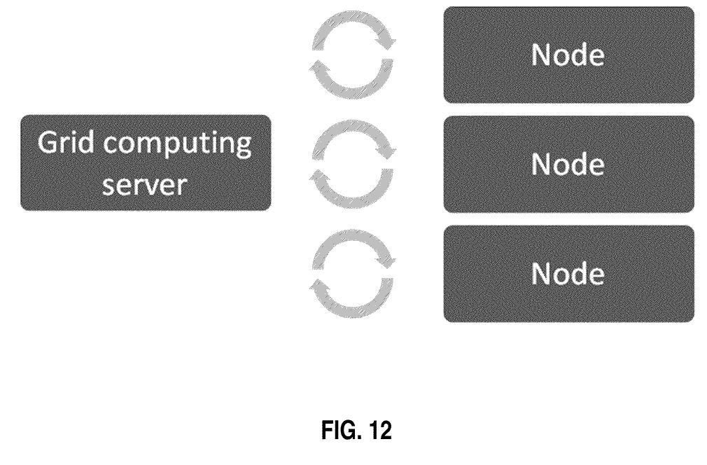

In an operation as shown in FIG. 12, each node computes its own assigned work unit. Such work unit computation may be performed independently from other nodes or the computation may have interdependence amongst nodes.

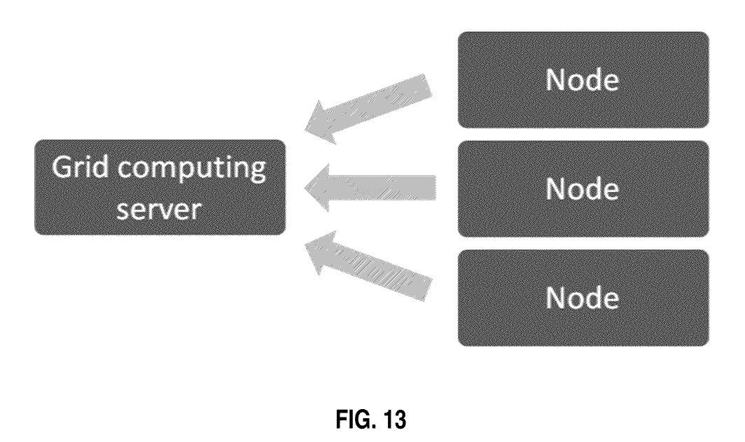

In an operation as shown in FIG. 13, once computation on work units is complete, then nodes send their assigned work unit results back to the server. The server may receive, for example, thousands of results at once.

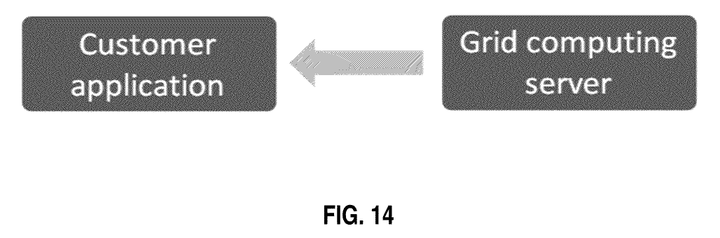

In an operation as shown in FIG. 14, the grid computing system server sends the work unit results to the customer application. Sending the work units is done at the convenience of the customer by downloading the work unit results from the server. The customer application compiles the results to create a meaningful answer to its original problem. The operations discussed above may repeat so long as the customer application is running.

### EXAMPLE 3

### Commercial Integration of Node Computers into a Grid Computing System Via an Internet Site Utilizing Iframe Java Applets

In this example, a contractually paid (e.g., per work unit) web site affiliate (e.g., a game site) has incorporated the grid computing system code within iframes. The affiliate site's web pages contain grid computing system code. Using the game site as an analogy to the iframe example in general, when a user goes to the affiliate game site, and upon accessing a game site web page, the grid computing system code is activated via Java applet(s) incorporated in the web page's iframe. The resulting capture of a new node computer is maintained throughout the user's visit to the game site and continues even after the user has picked a game to play and plays it, so long as one of the web pages from the game site remains open. The grid computing system and the new node function together as an expanded grid similar to that described in Example 1. Customers of the grid computing system may access the grid computing power of the described embodiment in an efficient and customizable sense as per Example 2.

### EXAMPLE 4

### Commercial Integration of Node Computers into a Grid Computing System Via an Internet Site Utilizing Web-Based Flash Files

In this example, a contractually paid (e.g., per work unit) web site affiliate has incorporated the grid computing system code within Flash files available on its web site, as per Example 1. When a computer user runs the Flash file available at that site, while connected to the Internet, the Flash file will in turn run the grid computing node application, allowing the computer to connect to the grid computing system and become a node within the network. The node application allows the system to utilize the computer's resources for various applications. By connecting to computers via the World Wide Web through Flash, the grid computing system allows exploitation of the fact that node computers are only using a small percentage of their total computing resources while viewing or using a Flash file. Further, unlike the iframe example, the embedded Flash file allows connection and utilization to and of the grid computing system even if the source web page is closed (so long as the Flash file is kept open). The grid computing system and the new node function together as an expanded grid similar to that described in Example 1. Customers of the grid computing system may access the grid computing power of the described embodiment in an efficient and customizable sense as per Example 2.

### EXAMPLE 5

### Commercial Integration of Node Computers into a Grid Computing System Via the Internet Utilizing Silverlight and Other Web-Based Applets and Web-Browser Plug-Ins

In this example, a contractually paid web site affiliate has incorporated the grid computing system code within Silverlight or other Rich Internet Applications (RIAs). RIAs are web applications that have some of the characteristics of desktop applications, typically delivered by way of an Ajax framework, web browser plug-ins, advanced JavaScript compiler technology, or independently via sandboxes or virtual machines. Examples of RIA frameworks that require browser extensions include Adobe AIR, Java/JavaFX, and Microsoft Silverlight, while examples of RIA frameworks that make comprehensive use of JavaScript include GWT and Pyjamas. When a computer runs the RIA, while connected to the Internet, the RIA will in turn run the grid computing client/node application, allowing the computer to connect to the grid computing system and become a client/node within the network. The client/node application allows the system to utilize the computer's resources for various applications. By connecting to computers via the World Wide Web through RIA, the grid computing system allows exploitation of the fact that node computers are only using a small percentage of their total computing resources while viewing or using RIA. Further, unlike the iframe example, the embedded RIA allows connection and utilization to and of the grid computing system even if the source web page is closed (so long as the RIA is kept open). The grid computing system and the new node function together as an expanded grid similar to that described in Example 1. Customers of the grid computing system may access the grid computing power of the described embodiment in an efficient and customizable sense as per Example 2.

### EXAMPLE 6

### Commercialization of Web-Based Grid Computer System Utilized for Bandwidth-Intensive Applications

In this example, the grid-computing system is utilized to provide efficient and low cost access to multiple nodes as described in Example 1. The system is then used to maximize bandwidth available for, e.g., web crawling. The grid computing system sends numerous web links to a node. The node travels to all of those web pages and finds all of the links that they contain, etc. The node then returns all the new links to the grid computing system. Customers, such as web search engines, of the grid computing system's web crawling data may access the grid computing power and/or results provided by the described embodiment in an efficient and customizable sense as per Example 2. Utilizing available bandwidth on nodes in the grid-computing system is desirable because doing so takes advantage of excess bandwidth on nodes. This excess bandwidth can be used for the purposes of other parties, thereby increasing the overall efficiency and usability of the entire Internet.

### EXAMPLE 7

### Commercialization of Web-Based Grid Computing System by the Use of Contracts and Terms of Use

In this example, purveyors of web sites and pages are contractually paid per work unit to imbed the grid computing system code either in their web pages or into web-based applets described above. Thus, an affiliate is incentivized to seek out additional visitors to its website. While such visitors, when allowing their computers to be used as nodes, could potentially be contractually paid for the utilization of their computer resources, the compensation for such visitors is usually in the form of indirect benefits from the monetization of the affiliate's website (improved website experience, better games, etc.). Whether or not direct compensation occurs, access to node resources by the grid computing system is only undertaken after the visitor agrees to a generalized (to the website) or specific (to the grid computing system) terms of service disclosure.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
receiving a data component request from a node computer of a grid computing system, the request indicates that the node computer is configured to process the data component as a part of the grid computing system;
sending a data component to the node computer, the data component is configured to be processed by a grid computing system web-based processing program executing in a web browser of the node computer; and
causing the node computer to apply the processing program to the data component to produce a result.

2. The method of claim 1, further comprising:
receiving from the node computer a result of the application of the processing program to the data component; and
providing the result to a user of the grid computing system.

3. The method of claim 1, further comprising downloading the web-based processing program to the node computer, the processing program is configured to execute in the web browser of the node computer and performs a processing function of the grid computing system.

4. The method of claim 1, further comprising:
providing a grid computing client program included on a web page accessed by the node computer, the client program is configured to be executed in the web browser of the node computer, and when downloaded to the node computer causes the node computer to operate as a part of the grid computing system.

5. The method of claim 1, further comprising downloading a web-based program to the node computer that when executed by the node computer configures the node computer to perform a grid computing system processing function using a predetermined percentage of the computing resources of the node computer.

6. The method of claim 1, further comprising providing a grid computing client program that when downloaded and executed by the node computer configures the node computer to operate as a part of the grid computing system as long as the web browser of the node computer accesses a web page comprising the grid computing client program.

7. The method of claim 1, further comprising providing a grid computing client program that when embedded in at least one of a Java applet, a Flash file, and a Rich Internet Application downloaded to the node computer causes the node computer to operate as a part of the grid computing system.

8. The method of claim 1, further comprising providing a web-based program that configures the node computer to operate as a part of the grid computing system only after receiving permission from a user of the node computer to include the node computer in the grid computing system, said permission granted by acknowledging one of a specific terms of use and a general terms of use of a web page accessed by the web browser of the node computer.

9. The method of claim 1, further comprising computing a remuneration for each data component sent.

10. The method of claim 1, further comprising downloading to the node computer a web-based program that utilizes web page monitoring and security to prevent unauthorized access to data on the node computer.

11. A computer readable medium encoded with a computer program comprising:
instructions that when executed cause a processor to receive a data component request from a node computer of a grid computing system, the request indicates that the node computer is configured to process the data component as a part of the grid computing system;
instructions that when executed cause a processor to send a data component to the node computer, the data component is configured to be processed by a grid computing system web-based processing program executing in a web browser of the node computer; and
instructions that when executed cause the node computer to apply the processing program to the data component to produce a result.

12. The computer readable medium of claim 11, further comprising instructions that when executed cause a processor to download the web-based processing program to a node computer, the processing program executes in the web browser of the node computer and performs a processing function of a grid computing system.

13. The computer readable medium of claim 11, further comprising instructions that when executed cause a processor to receive a result of the application of the processing program to the work unit transferred from the node computer, and to transfer the result to a user of the grid computing system.

14. A computer readable medium encoded with a computer program comprising:
instructions that when executed cause a processor to download from a first computer to a second computer a web-based program that executes in a web browser of the second computer; and
instructions that when executed cause a processor to configure the second computer to operate as a node of a grid computing system by execution of the web-based program.

15. The computer readable medium of claim 14, further comprising instructions that when executed cause a processor to configure the second computer to perform a grid computing system processing function during a time interval when the computing resources of the second computer are not fully utilized.

16. The computer readable medium of claim 14, further comprising instructions that when executed cause a processor to configure the second computer to operate as a node of the grid computing system during an interval in which the web browser of the second computer accesses a web page comprising the web-based program.

17. The computer readable medium of claim 14, further comprising instructions that when executed cause a processor to execute a grid computing client embedded within at least one program from a group consisting of a Java applet, a Flash file, and a Rich Internet Application, the grid computing client when executed causes the second computer to operate as a node of the grid computing system.

18. The computer readable medium of claim 14, further comprising instructions that when executed cause a processor to configure the second computer to operate as a node of the grid computing system only after receiving permission from a user of the second computer to include the second computer in the grid computing system, said permission granted by acknowledging one of a specific terms of use and a general terms of use of a web page accessed by the web browser of the second computer.

19. The computer readable medium of claim 14, further comprising instructions that when executed cause a processor to configure the second computer to operate as a node of the grid computing system unless a denial of permission to include the second computer in the grid computing system is received via one of a specific terms of use and a general terms of use of a web page accessed by the web browser of the second computer.

20. A grid computing system, comprising:
a first computer comprising:
a grid computer processing server; and
a network connection configured to couple the first computer to a plurality of node computers;
wherein the grid computer processing server is configured to receive data component requests from the plurality of node computers, each request indicating that a node computer is configured to process the data component as part of the grid computing system;
wherein the grid computer processing server is configured to send a data component to a given node computer in response to receiving a data component request from the given node computer, the data component is configured to be processed by a grid computing system web-based processing program executing in a web browser of the node computer.

21. The grid computing system of claim 20, wherein the first computer distributes the web-based processing program to each of the plurality of node computers, the web-based processing program is configured to execute within a web browser of each node computer, and causes each node computer to perform a processing function of the grid computing system.

22. The grid computing system of claim 20, wherein the grid computer processing server receives from a customer application server, via the network, a work item and a web-based processing program configured to process the work item, segments the work item into data components, assigns an identifier to each component, and transmits the identifiers to the customer application server.

23. The grid computing system of claim 20, wherein the grid computer processing server receives from each node computer a result of the web-based processing program applied to the data component by the node computer; the grid computer processing server transfers the result to the customer application server.

24. The grid computing system of claim 20, further comprising a web page comprising a web-based program configured to execute in a web browser; when executed the web-based program causes a computer to operate as one of the plurality of node computers.

25. The grid computing system of claim 24, wherein the web-based program comprises at least one of an application program selected from a group consisting of a Java applet, a Flash file, and a Rich Internet Application, and wherein the web-based program configures the node to operate as one of the plurality of node computers for as long as the application program executes.

26. The grid computing system of claim 20, wherein the grid computing system is configured to perform at least one of gene mapping, Monte Carlo simulation, financial market analysis, web crawling, mining web page data, and weather prediction.

27. A method, comprising:
downloading a web-based processing function and a work unit to process with the processing function to a node computer of a grid based computing system; and
computing a remuneration based on a number of work units processed by the node computer.

28. The method of claim 27, further comprising providing the remuneration to a proprietor of a web page that downloads a web-based program to the node computer, the web-based program causes the node computer to operate as part of the grid based computing system.

29. The method of claim 27, further comprising providing the remuneration to a developer of a web-based application program consisting of at least one of a Java applet, a Rich Internet Application, and a Flash file, the web-based application program when downloaded to the node computer causes the node computer to operate as part of the grid based computing system.
